(19) United States
(12) Patent Application Publication
(10) Pub. No.: US 2015/0159505 A1
(43) Pub. Date: Jun. 11, 2015

(54) GAS TURBINE ORGANIC ACID BASED INTER-RINSE

(71) Applicant: General Electric Company, Schenectady, NY (US)

(72) Inventors: Alston Ilford Scipio, Mableton, GA (US); Sanji Ekanayake, Mableton, GA (US); Dale J. Davis, Greenville, SC (US); Rebecca Evelyn Hefner, Fountain Inn, SC (US)

(73) Assignee: General Electric Company, Schenectady, NY (US)

(21) Appl. No.: 14/098,627

(22) Filed: Dec. 6, 2013

(51) Int. Cl. F01D 25/00; B08B 3/08

(52) U.S. Cl. CPC F01D 25/002; B08B 3/08

(57) ABSTRACT

A gas turbine wash control system may perform a wash and a rinse of a gas turbine that is offline. An inter-rinse solution may be injected into the gas turbine. The gas turbine may be agitated and the inter-rinse solution drained. A second rinse of the gas turbine may be performed followed by the injection of an anticorrosive solution into the gas turbine.

### BACKGROUND

Gas turbines, which may also be referred to as combustion turbines, are internal combustion engines that pressurize air and add heat to the air by combusting fuel in a chamber to increase the temperature of the gases that make up the air, expanding the gases. The gases are then directed towards a turbine to extract the energy generated by the hot, expanded gases. Gas turbines have many practical applications, including use as jet engines and in industrial power generation systems. Gas turbines are exposed to a variety of atmospheric and environmental factors during normal operation. While most stationary gas turbines are equipped with an inlet air filtration system, it is not possible to prevent all atmospheric and environmental matter from entering the turbine.

Because atmospheric and environmental matter enters a gas turbine despite filtering of incoming air, turbine components become fouled over time by such matter. To address this fouling, gas turbine components may be cleaned or “washed” offline (i.e., when not in operation) and online (i.e., while operating). However, even when performing turbine washes regularly, some fouling may remain on the components of a gas turbine and a residue of the cleaning fluids used to wash the gas turbine may also accumulate on such components. Rust may also appear on components of a gas turbine. The lack of complete cleaning by wash processes may be due to various factors, including the limited reach of wash detergents to higher numbered compressor stages of a gas turbine resulting in these stages being less thoroughly washed, inadequate rinsing during the wash process leaving residual detergents, and unreliable detergent distribution nozzles. Rust may begin to appear due to inadequate drying of the turbine following a wash process.

### BRIEF DESCRIPTION OF THE INVENTION

In an exemplary non-limiting embodiment, a system may include a gas turbine, a gas turbine washing system, and a wash controller configured to control the gas turbine washing system to cause the gas turbine washing system to perform a wash of the gas turbine and a first rinse of the gas turbine. The system may inject inter-rinse solution into the gas turbine, agitate the gas turbine, and perform a second rinse of the gas turbine. The system may inject anticorrosive solution into the gas turbine.

In another exemplary non-limiting embodiment, a method is disclosed for performing a wash of a gas turbine that is offline and performing a first rinse of the gas turbine. Inter-rinse solution may be injected into the gas turbine, the gas turbine agitated, and a second rinse of the gas turbine may be performed. An anticorrosive solution may be injected into the gas turbine.

In another exemplary non-limiting embodiment, a gas turbine wash controller is disclosed that may include a memory with instruction and a processor coupled to the memory, wherein the wash controller effectuates operations including performing a wash of a gas turbine that is offline and performing a first rinse of the gas turbine. The operations may further include injecting inter-rinse solution into the gas turbine, agitating the gas turbine and performing a second rinse of the gas turbine. The operations may further include injecting anticorrosive solution into the gas turbine.

The foregoing summary, as well as the following detailed description, is better understood when read in conjunction with the drawings. For the purpose of illustrating the claimed subject matter, there is shown in the drawings examples that illustrate various embodiments; however, the invention is not limited to the specific systems and methods disclosed.

### BRIEF DESCRIPTION OF THE DRAWINGS

These and other features, aspects, and advantages of the present subject matter will become better understood when the following detailed description is read with reference to the accompanying drawings, wherein:

FIG. 1 is an illustration of an exemplary non-limiting gas turbine system;

FIG. 2 is another illustration of an exemplary non-limiting turbine system;

FIG. 3 is a schematic illustration of an exemplary non-limiting system for washing a gas turbine;

FIG. 4 illustrates a non-limiting, exemplary method of performing an offline wash of a gas turbine; and

FIG. 5 is an exemplary block diagram representing a general purpose computer system in which aspects of the methods and systems disclosed herein or portions thereof may be incorporated

### DETAILED DESCRIPTION OF THE INVENTION

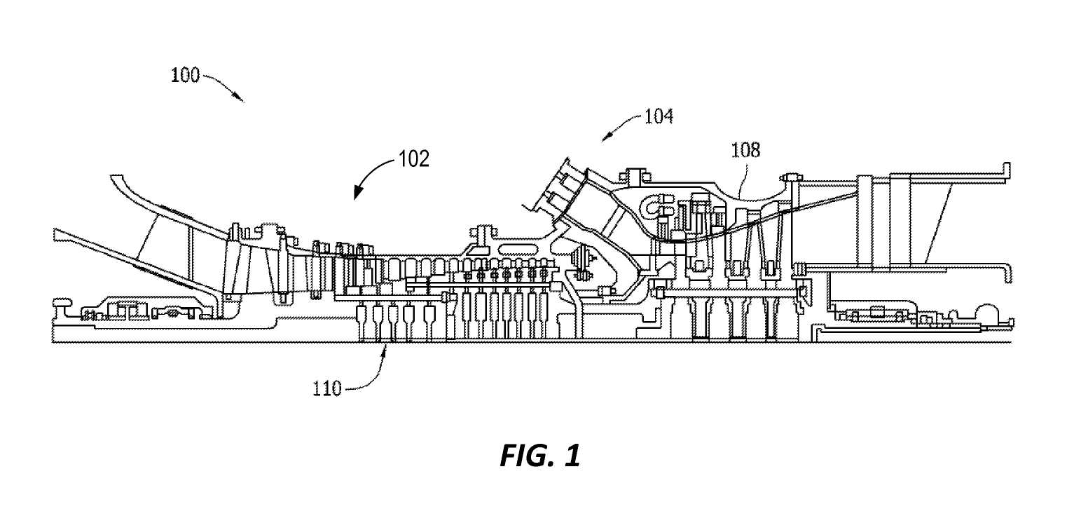

FIG. 1 is a schematic illustration of an exemplary non-limiting gas turbine engine 100. Engine 100 may include a compressor section 102 and a combustor assembly 104. Engine 100 may also include a turbine section 108 and a common compressor/turbine shaft 110 (may also be referred to as rotor 110).

In operation, air may flow through compressor section 102 such that compressed air is supplied to combustor assembly 104. Fuel may be channeled to a combustion region and/or zone (not shown) that is defined within combustor assembly 104 where the fuel may be mixed with the air and ignited. Combustion gases generated are channeled to turbine section 108 where gas stream thermal energy is converted to mechanical rotational energy. Turbine section 108 is rotatably coupled to shaft 110. It should also be appreciated that the term “fluid” as used herein includes any medium or material that flows, including, but not limited to, gas and air.

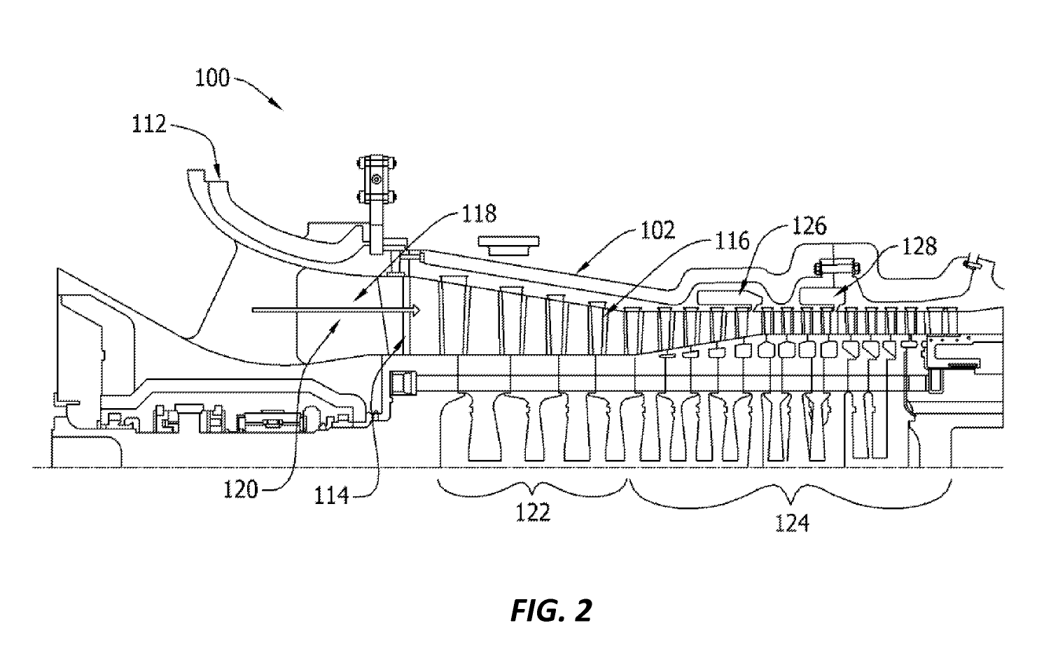

FIG. 2 is a schematic illustration of a non-limiting exemplary compressor section of exemplary turbine engine 100. Engine 100 may further include compressor bellmouth 112, inlet guide vanes 114, and compressor stator vanes 116. Gas turbine washing methods may involve the placement 118 of water wash nozzles (not shown), such that wash water follows a generally axial path 120 through compressor 102. Using such washing methods may result in effective cleaning only through first seven (or fewer) stages 122 of compressor 102, with latter stages 124 of compressor 102 not receiving adequate cleaning. Entry points 126 and 128 indicate entry points for the introduction of water, cleaning agents, or a mixture of water and one or more cleaning agents in an exemplary embodiment of the method, system and apparatus discussed herein, being located at the ninth (9th) stage and the thirteenth (13th) stages, respectively, of compressor 102.

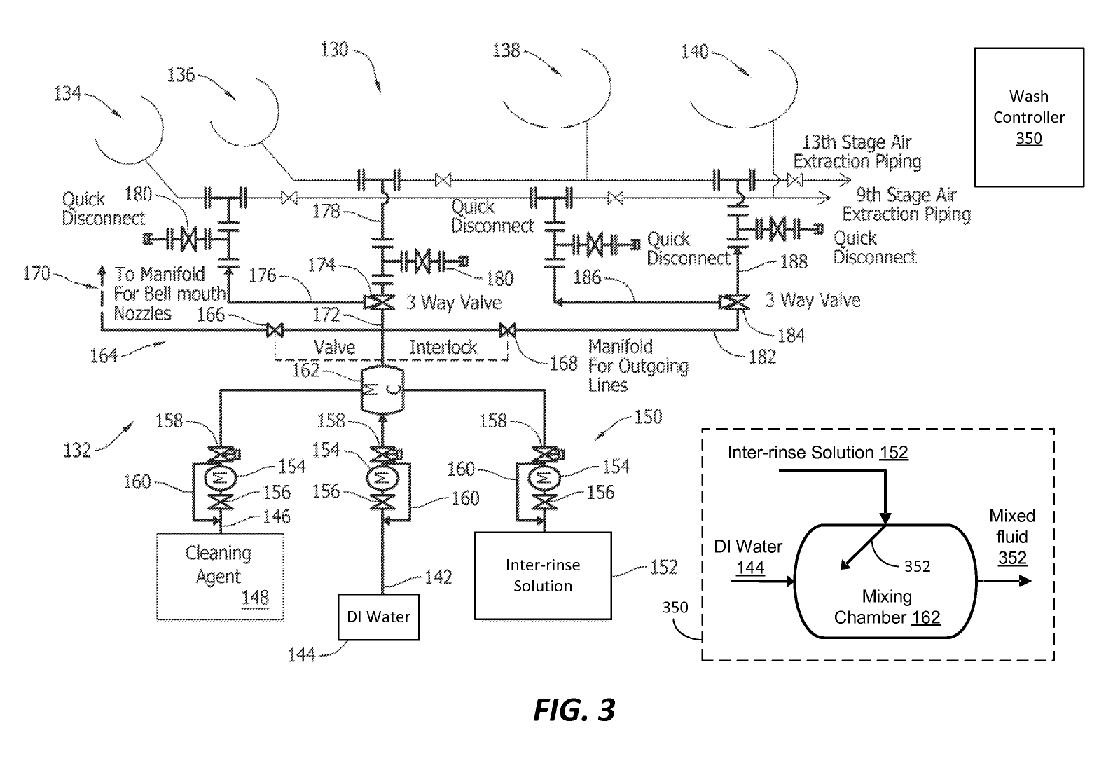

FIG. 3 is a schematic illustration of a non-limiting exemplary system 130 for washing a gas turbine such as turbine engine 100. System 130 may include fluid distribution piping 132 for supplying water, cleaning agents, and/or inter-rinse solution into turbine 100. In an exemplary embodiment, washing system 130 may be configured for washing of turbine 100 when turbine 100 is off line (not burning fuel or supplying power). In order to utilize washing system 130, turbine 100 may connected to turning gear and a driving motor (not shown). Furthermore, turbine 100 may be permitted to cool down after being taken offline, in some embodiments until the interior volume and surfaces have cooled sufficiently (e.g., to 145° F. or below) so that the water, cleaning mixture, or inter-rinse solution being introduced into turbine 100 will not thermally shock the internal metal and/or induce creep or any mechanical or structural deformation of the material of the turbine components.

In an exemplary embodiment, wash controller 350 may serve as a control system suitably programmed to control any aspects of the washing process, including a ratio of water to cleaning agent, a ratio of water to inter-rinse solvent, and cycle times for wash, rinse, inter-rinse application, and drying sequences. Note that a ratio of inter-rinse solvent to water may be determined based on blade material, turbine location, etc. In some embodiments, such aspects of the washing method may be selected by the turbine manufacturer to accommodate the specifications and configuration of the turbine being washed. Note that in some embodiments, such settings may not be adjusted manually or by unauthorized personnel, while in other embodiments, such settings may be user-adjustable. Wash controller 350 may be configured to perform checks and prevent the commencement of an offline wash cycle or any aspect of an offline wash if certain conditions are not met. For example, wash controller 350 may be configured to determine that shaft 110 is connected to turning gear and/or a driving motor before commencement of a wash cycle. Wash controller 350 may be communicatively connected to (connections not shown), and may control or instruct, any of the components of a gas turbine engine and/or a wash system as described herein and as known to those skilled in the art. Such communications and instructions may be conveyed using wired communications, wireless communications, or any combination of such communications.

In exemplary washing system 130 fluid distribution piping 132 may be connected to existing compressor air extraction piping 134 and 136, in an embodiment, at the 9th and 13th compressor stages, and existing turbine cooling piping 138 and 140, in an embodiment at the 2nd and 3rd turbine stages. Such stages may already be present in current turbine constructions. The foregoing additional piping arrangements are, in exemplary washing system 130, employed in conjunction with, or as an alternative to, bellmouth nozzles (not shown).

Fluid distribution piping 132 may include water supply piping 142 connected to a source 144 of water (preferably deionized water), as well as cleaning agent supply piping 146 connected to one or more sources 148 of cleaning agent, with additional valving (not shown) that may enable selection between different sources of cleaning agent, for example, for cleaning the compressor section 102 versus the turbine section 108.

Fluid distribution piping 132 of system 130 may include inter-rinse solution piping 150 connected to a supply 152 of an inter-rinse solution. Supply 152 may be stationary and located proximate to engine 100, or may be mobile, for example, on a truck that is used when offline cleaning is to be performed. Such an inter-rinse solution may remove, partially or entirely, any residual fouling and/or detergents and rust deposits within turbine 100. In an embodiment, the inter-rinse solution may be used following a first wash and rinse cycle of an offline wash, after which an additional rinse may be performed and then an application of an anticorrosive treatment solution (e.g., a polyamine application) may be performed. Each of water supply piping 142, cleaning agent supply piping 146 and inter-rinse solution piping 150 may include a pump 154 that may have a motor, as well as valves 156 and 158 and return flow circuits 160.

In an embodiment, the inter-rinse solution stored in supply 152 and used as described herein may be a blend of citric acid and demineralized water. Any concentration of citric acid in such a blend is contemplated as within the scope of the present disclosure. Any other inter-rinse solution may be used in other embodiments, and such inter-rinse solutions may assist in removing residual fouling and detergents, removing rust deposits, passivating internal compressor metallic surfaces, and/or improving the surface adsorption potential for an anticorrosive treatment. The increased range of coverage provided by the anticorrosive material may enhance a compressor's ability to suppress or reduce the formation rate of surface rust and other corrosive components in and on casing, wheels, and wheel fittings. In some embodiments, a same inter-rinse solution may be simultaneously injected into a compressor (e.g., via bellmouth nozzles and the two latter stage access points) and the turbine section. In other embodiments, dissimilar solutions or cleaning compositions may be injected into a compressor and turbine sections, and in such embodiments, there may be configured more than one mixing chamber 162 and inter-rinse solution supply 152, and corresponding piping, to allow for the injection of dissimilar inter-rinse solutions. In other embodiments, inter-rinse solution may be applied only to a compressor section without application to turbine section components, or vice-versa. All such embodiments are contemplated as within the scope of the present disclosure.

Water supply piping 142, cleaning agent supply piping 146, and inter-rinse solution piping 150 may lead into mixing chamber 162, with the water forming a primary stream and the cleaning agent and inter-rinse solution forming secondary streams directed into the primary water stream to ensure thorough mixing. In an embodiment, as shown in the expanded view shown in FIG. 3, the inter-rinse solution may be injected into mixing chamber 162 at a higher pressure than the primary fluid through one or more nozzles angled at a counter-flow direction relative to the primary fluid flow direction. From mixing chamber 162, inter-rinse solution, in some embodiments mixed with DI water, may be directed to supply manifold 164, controlling the outflow from mixing chamber 162. Manifold 164 may include interlocked valves 166 and 168 that, in an exemplary embodiment, may be controlled so that only one or the other of valves 166 and 168 may be open at any given time. In other embodiments, both of valves 166 and 168 may be opened at once. In either embodiment, both of valves 166 and 168 may be closed simultaneously. In some embodiments, valves 166 and 168 may be separately and independently controllable.

From manifold 164, supply branch 170 provides inter-rinse solution or a mixture of inter-rinse solution and DI water to bellmouth 112 of turbine 100 when the appropriate valves are suitably configured. Similarly, supply line 172 may lead to three-way valve 174 that may lead to supply branches 176 and 178 to supply provides inter-rinse solution or a mixture of inter-rinse solution and DI water, in some embodiments simultaneously, to ninth (9^{th}) compressor stage air extraction piping 134 and thirteenth (13^{th}) compressor stage air extraction piping 136, respectively. Branches 176 and 178 may each be provided with quick disconnects 180 that may be provided to allow the addition of specialty cleaning agents. Supply piping 182 may extend from manifold 164 to three-way valve 184 and on to branches 186 and 188 to supply inter-rinse solution or a mixture of inter-rinse solution and DI water, in some embodiments simultaneously, to second (2^{nd}) turbine stage cooling piping 138 and third (3^{rd}) turbine stage cooling piping 140, respectively. Branches 186 and 188 may likewise be provided with quick disconnects 180, again, for use when specialty cleaning agents are employed and/or sourced from external supplies, such as a truck or other external source of cleaning agents or other fluids. In an embodiment, water and citric acid alone may be mixed in a predetermined ratio. In some embodiments, mixing may be performed in another location or at another component other than the mixing chamber disclosed herein, such as a separate storage tank. The inter-rinse solution fluid mixture may be determined based on the material metallurgy of the gas turbine frame size, as may be the duration of a wash treatment. The ratio may also be adjusted based on the type of citric acid compound used in the fluid mixture.

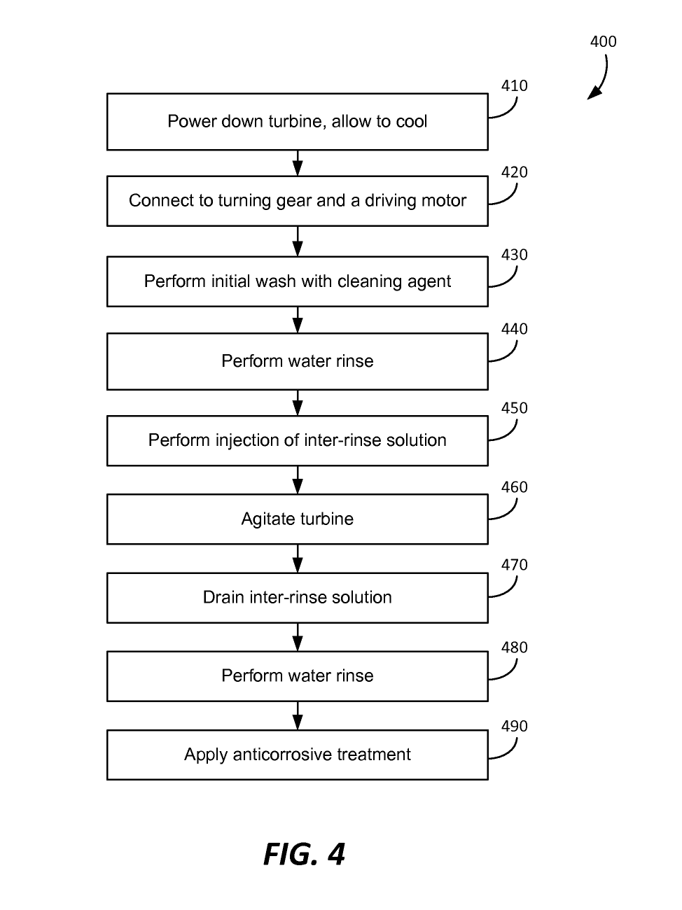

FIG. 4 illustrates exemplary non-limiting method 400 of performing an offline gas turbine wash. The functions and operations described in regard to FIG. 4 may be performed, initiated, or otherwise controlled by a device such as wash controller 350. Note that the functions and operations described in regard to the various blocks of method 400 may be performed in any order, and any subset of such functions and operations or any individual function or operation may be performed in isolation or in combination with any other functions and operations described herein or not described herein. All such embodiments are contemplated as within the scope of the present disclosure.

At block 410, a gas turbine may be power down or otherwise placed in an offline condition. In some embodiments, before commencing an offline wash cycle, the gas turbine may be allowed to cool until it is at or below a predetermined temperature. In some embodiments a wash controller may use one or more sensors configured on the gas turbine to determine a temperature at one or more sections of the gas turbine and may inhibit commencement of an offline wash cycle until the detected temperature(s) are at or below a threshold.

At block 420, the gas turbine may be connected, or a determination may be made (e.g., by a wash controller) as to whether the gas turbine is connected, to turning gear and/or a driving motor. If not, a wash controller, for example, may inhibit further commencement of the offline wash cycle until a connection to a turning gear and/or a driving motor is confirmed. Alternatively, or in addition, upon determining that the gas turbine is not connected to turning gear and/or a driving motor, an alarm may be issued or some other form of notification may be generated by a wash controller.

At block 430, an initial wash of the gas turbine may be performed using a mixture of one or more cleaning agents and DI water. Any type of cleaning of the gas turbine may be performed. At block 440 a water rinse may be performed to remove as much of the cleaning agent from the gas turbine as possible. Note that in either or both of blocks 430 and 440, the gas turbine may be agitated or otherwise manipulated by the connected turning gear and/or driving motor to improve the effectiveness of the wash and/or rinse.

At block 450, inter-rinse solution may be injected into the gas turbine. The inter-rinse solution may be mixed with water. In an embodiment, the inter-rinse solution used may be a blend of citric acid and demineralized water. Any concentration of citric acid in such a blend is contemplated as within the scope of the present disclosure. Any other inter-rinse solution may be used in other embodiments, and such inter-rinse solutions may assist in removing residual fouling and detergents, removing rust deposits, passivating internal compressor metallic surfaces, and/or improving the surface adsorption potential for an anticorrosive treatment. In some embodiments, the ratio of inter-rinse solution to water may be determined by a wash controller. In an embodiment, the inter-rinse solution may be injected into the compressor via the ninth (9^{th}) and thirteenth (13^{th}) stages of the gas turbine's compressor using water wash circuits and extraction air piping already configured at the gas turbine. The inter-rinse solution may also, or instead, be injected into the gas turbine bellmouth using bellmouth injection nozzles. Inter-rinse solution may also, or instead, be injected into the second (2^{nd}) turbine stage the third (3^{rd}) turbine stage. In some embodiments, the same mixture of inter-rinse solution and water may be used at both the turbine and the compressor, while in other embodiments, dissimilar solutions or cleaning compositions may be injected into the compressor and turbine sections. In those embodiments using dissimilar mixtures, more than one mixing chamber may be used to mix the inter-rinse solutions. In other embodiments, inter-rinse solution may be applied only to a compressor section without application to combustion components, or vice-versa. All such embodiments are contemplated as within the scope of the present disclosure.

At block 460, the turbine may be agitated or otherwise manipulated by the connected turning gear, driving motor, and/or starting system to increase coverage of the inter-rinse solution on the blades, vanes, and other components of the gas turbine. This agitation may be performed for a predetermined amount of time and/or at a predetermined speed that may be set at a wash controller, in an embodiment configured in the wash controller's programming or logic.

At block 470, the inter-rinse solution may be drained from the gas turbine, in an embodiment upon rotation of the turbine to achieve drain valve alignment. Note that in some embodiments, the inter-rinse solution may be reusable, and in such embodiments drains at the gas turbine may be modified to capture the draining inter-rinse solution.

At block 480, a water rinse may be performed to rinse the inter-rinse solution from the gas turbine. An agitation may be performed, in some embodiments, for a predetermined amount of time and/or at a predetermined speed that may be set at a wash controller. This agitation may assist in a more thorough rinsing of the inter-rinse solution from the gas turbine. The rinse water may be drained and, where the inter-rinse solution is reusable, may also be captured using modified drains.

At block 490, an anticorrosive solution may be injected into the gas turbine. Such a solution may help inhibit corrosion of the components of the gas turbine. In an embodiment, the anticorrosive solution may be a polyamine solution or may contain a polyamine compound. As used herein, the term “polyamine” is used to refer to an organic compound having two or more primary amino groups such as NH₂. In another embodiment, the anticorrosive solution may include a volatile neutralizing amine that may neutralize acidic contaminants and elevate the pH into an alkaline range, and with which protective metal oxide coatings are particularly stable and adherent. Nonlimiting examples of the anticorrosion agents that may be used in such a solution include cyclohexylamine, morpholine, monoethanolamine, N-9-octadecenyl-1,3-propanediamine, 9-octadecen-1-amine, (Z)-1-5, dimethylaminepropylamine (DMPA), diethylaminoethanol (DEAE), and the like, and any combination thereof. An alignment and positioning of inlet and drain valves may be performed to ensure proper distribution of the anticorrosive solution. An agitation may also, or instead, be performed to ensure a more even and thorough distribution of the anticorrosive solution. This agitation may be performed for a predetermined amount of time and/or at a predetermined speed that may be set at a wash controller.

The technical effect of the systems and methods set forth herein is the improved distribution and coverage of anticorrosive solution by ensuring that a gas turbine is more thoroughly cleaned before application of the anticorrosive solution. Better cleaning of gas turbine components using the instant system and methods will also help maintain recovered performance for longer duration, improve gas turbine performance, efficiency, and lifespan, as will be appreciated by those skilled in the art. Those skilled in the art will recognize that the disclosed systems and methods may be combined with other systems and technologies in order to achieve even greater gas turbine cleanliness, performance, and efficiency. All such embodiments are contemplated as within the scope of the present disclosure.

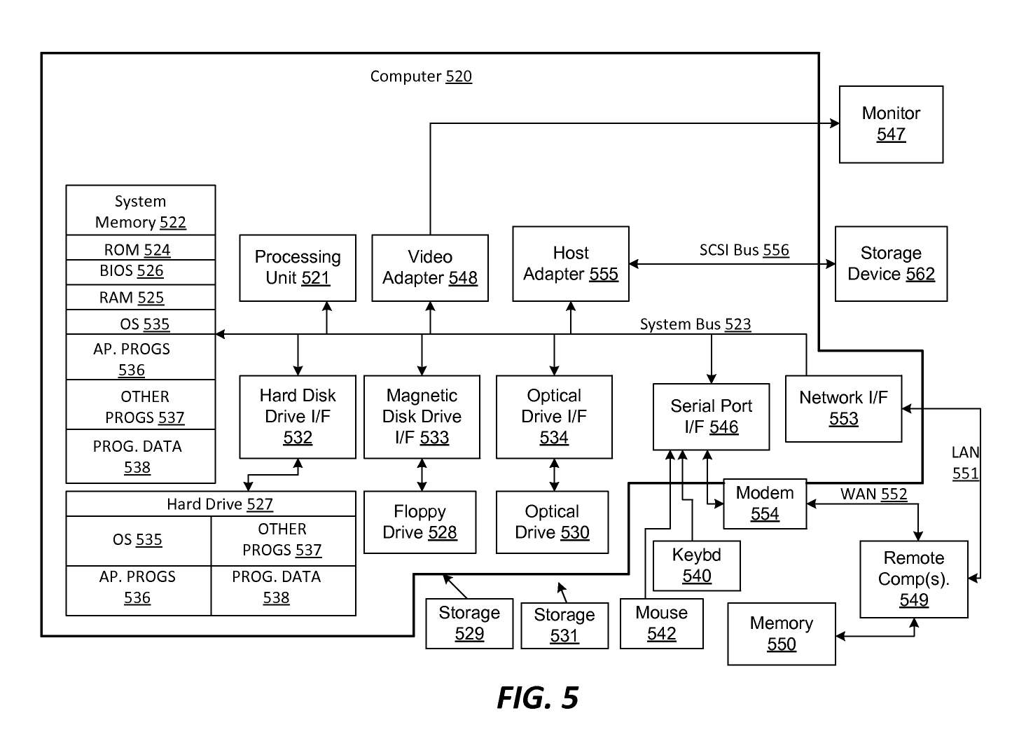

FIG. 5 and the following discussion are intended to provide a brief general description of a suitable computing environment in which the methods and systems for gas turbine inter-rinse as disclosed herein and/or portions thereof may be implemented. For example, the functions of wash controller 350 may be performed by one or more devices that include some or all of the aspects described in regard to FIG. 5. Some or all of the devices described in FIG. 5 that may be used to perform functions of the claimed embodiments may be configured in a controller that may be embedded into a system such as those described with regard to FIG. 3. Alternatively, some or all of the devices described in FIG. 5 may be included in any device, combination of devices, or any system that performs any aspect of a disclosed embodiment.

Although not required, the methods and systems for gas turbine inter-rinse as disclosed herein may be described in the general context of computer-executable instructions, such as program modules, being executed by a computer, such as a client workstation, server or personal computer. Such computer-executable instructions may be stored on any type of computer-readable storage device that is not a transient signal per se. Generally, program modules include routines, programs, objects, components, data structures and the like that perform particular tasks or implement particular abstract data types. Moreover, it should be appreciated that the methods and systems for gas turbine inter-rinse as disclosed herein and/or portions thereof may be practiced with other computer system configurations, including hand-held devices, multi-processor systems, microprocessor-based or programmable consumer electronics, network PCs, minicomputers, mainframe computers and the like. The methods and systems for gas turbine inter-rinse as disclosed herein may also be practiced in distributed computing environments where tasks are performed by remote processing devices that are linked through a communications network. In a distributed computing environment, program modules may be located in both local and remote memory storage devices.

FIG. 5 is a block diagram representing a general purpose computer system in which aspects of the methods and systems for gas turbine inter-rinse as disclosed herein and/or portions thereof may be incorporated. As shown, the exemplary general purpose computing system includes computer 520 or the like, including processing unit 521, system memory 522, and system bus 523 that couples various system components including the system memory to processing unit 521. System bus 523 may be any of several types of bus structures including a memory bus or memory controller, a peripheral bus, and a local bus using any of a variety of bus architectures. The system memory may include read-only memory (ROM) 524 and random access memory (RAM) 525. Basic input/output system 526 (BIOS), which may contain the basic routines that help to transfer information between elements within computer 520, such as during start-up, may be stored in ROM 524.

Computer 520 may further include hard disk drive 527 for reading from and writing to a hard disk (not shown), magnetic disk drive 528 for reading from or writing to removable magnetic disk 529, and/or optical disk drive 530 for reading from or writing to removable optical disk 531 such as a CD-ROM or other optical media. Hard disk drive 527, magnetic disk drive 528, and optical disk drive 530 may be connected to system bus 523 by hard disk drive interface 532, magnetic disk drive interface 533, and optical drive interface 534, respectively. The drives and their associated computer-readable media provide non-volatile storage of computer-readable instructions, data structures, program modules and other data for computer 520.

Although the exemplary environment described herein employs a hard disk, removable magnetic disk 529, and removable optical disk 531, it should be appreciated that other types of computer-readable media that can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on hard disk drive 527, magnetic disk 529, optical disk 531, ROM 524, and/or RAM 525, including an operating system 535, one or more application programs 536, other program modules 537 and program data 538. A user may enter commands and information into the computer 520 through input devices such as a keyboard 540 and pointing device 542. Other input devices (not shown) may include a microphone, joystick, game pad, satellite disk, scanner, or the like. These and other input devices are often connected to the processing unit 521 through a serial port interface 546 that is coupled to the system bus, but may be connected by other interfaces, such as a parallel port, game port, or universal serial bus (USB). A monitor 547 or other type of display device may also be connected to the system bus 523 via an interface, such as a video adapter 548. In addition to the monitor 547, a computer may include other peripheral output devices (not shown), such as speakers and printers. The exemplary system of FIG. 5 may also include host adapter 555, Small Computer System Interface (SCSI) bus 556, and external storage device 562 that may be connected to the SCSI bus 556.

The computer 520 may operate in a networked environment using logical and/or physical connections to one or more remote computers or devices, such as wash controller 350. Wash controller 350 may be any device as described herein capable of performing aspects of the disclosed embodiments. Remote computer 549 may be a personal computer, a server, a router, a network PC, a peer device or other common network node, and may include many or all of the elements described above relative to the computer 520, although only a memory storage device 550 has been illustrated in FIG. 5. The logical connections depicted in FIG. 5 may include local area network (LAN) 551 and wide area network (WAN) 552. Such networking environments are commonplace in offices, enterprise-wide computer networks, intranets, and the Internet.

When used in a LAN networking environment, computer 520 may be connected to LAN 551 through network interface or adapter 553. When used in a WAN networking environment, computer 520 may include modem 554 or other means for establishing communications over wide area network 552, such as the Internet. Modem 554, which may be internal or external, may be connected to system bus 523 via serial port interface 546. In a networked environment, program modules depicted relative to computer 520, or portions thereof, may be stored in a remote memory storage device. It will be appreciated that the network connections shown are exemplary and other means of establishing a communications link between computers may be used.

Computer 520 may include a variety of computer-readable storage media. Computer-readable storage media can be any available tangible, non-transitory, or non-propagating media that can be accessed by computer 520 and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer-readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computer 520. Combinations of any of the above should also be included within the scope of computer-readable media that may be used to store source code for implementing the methods and systems described herein. Any combination of the features or elements disclosed herein may be used in one or more embodiments.

This written description uses examples to disclose the subject matter contained herein, including the best mode, and also to enable any person skilled in the art to practice the invention, including making and using any devices or systems and performing any incorporated methods. The patentable scope of this disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a gas turbine;
a gas turbine washing system comprising inter-rinse solution and anticorrosive solution; and
a wash controller configured to control the gas turbine washing system to effectuate operations comprising:
performing a wash of the gas turbine when the gas turbine is offline;
performing a first rinse of the gas turbine;
injecting the inter-rinse solution into the gas turbine;
agitating the gas turbine;
performing a second rinse of the gas turbine; and
injecting the anticorrosive solution into the gas turbine.

2. The system of claim 1, wherein the inter-rinse solution comprises citric acid.

3. The system of claim 1, wherein the anticorrosive solution comprises a polyamine compound.

4. The system of claim 1, wherein the system further comprises at least one of a turning gear or a driving motor, and wherein the operations further comprise verifying that the gas turbine is connected to at least one of the turning gear or the driving motor.

5. The system of claim 1, wherein the gas turbine is agitated for a predetermined amount of time.

6. The system of claim 1, wherein the gas turbine is agitated at a predetermined speed.

7. The system of claim 1, wherein the operations further comprise draining the inter-rinse solution from the gas turbine.

8. A method comprising:
performing a wash of a gas turbine that is offline;
performing a first rinse of the gas turbine;
injecting inter-rinse solution into the gas turbine;
agitating the gas turbine;
performing a second rinse of the gas turbine; and
injecting anticorrosive solution into the gas turbine.

9. The method of claim 8, wherein the inter-rinse solution comprises citric acid.

10. The method of claim 8, wherein the anticorrosive solution comprises a polyamine compound.

11. The method of claim 8, further comprising verifying that the gas turbine is connected to at least one of a turning gear or a driving motor.

12. The method of claim 8, wherein the gas turbine is agitated for a predetermined amount of time.

13. The method of claim 8, wherein the gas turbine is agitated at a predetermined speed.

14. The method of claim 8, further comprising draining the inter-rinse solution from the gas turbine.

15. A gas turbine wash controller comprising:
a memory comprising instructions; and
a processor coupled to the memory, wherein the processor, when executing the instructions, effectuates operations comprising:
performing a wash of a gas turbine that is offline;
performing a first rinse of the gas turbine;
injecting inter-rinse solution into the gas turbine;
agitating the gas turbine;
performing a second rinse of the gas turbine; and
injecting anticorrosive solution into the gas turbine.

16. The gas turbine wash controller of claim 15, wherein the inter-rinse solution comprises citric acid.

17. The gas turbine wash controller of claim 15, wherein the anticorrosive solution comprises a polyamine compound.

18. The gas turbine wash controller of claim 15, wherein the operations further comprise confirming that the gas turbine is connected to at least one of a turning gear or a driving motor.

19. The gas turbine wash controller of claim 15, wherein the gas turbine is agitated for a predetermined amount of time.

20. The gas turbine wash controller of claim 15, wherein the operations further comprise draining the inter-rinse solution from the gas turbine.
